(19) United States
(12) Patent Application Publication
(10) Pub. No.: US 2012/0170732 A1
(43) Pub. Date: Jul. 5, 2012

(54) Methods and Devices for Providing a Called Party's Name to a Setup Message

(75) Inventors: Rodrigo Magosso Branchini, Ribeirao Preto, SP (BR); Eduardo Chaya, Campinas, SP (BR); Edson Dos Santos, Campinas, SP (BR); Alexandre Padrin Caldeira, Jaguariuna, SP (BR)

(73) Assignee: Motorola Mobility, Inc., Libertyville, IL (US)

(21) Appl. No.: 12/980,804

(22) Filed: Dec. 29, 2010

(51) Int. Cl. H04M 15/06

(52) U.S. Cl. 379/142.06

(57) ABSTRACT

Disclosed are communication devices and methods of a communication devices that include accessing the contact list of the memory by the controller, initiating communication based upon the contact list input by the controller and generating by the controller, a setup message that includes communication address data populating a field for a communication address and includes identification data populating a field for identification information. The disclosed method can further include transmitting a call setup message signal of a control channel, such as a stand-alone dedicated control channel including a populated field for identification information. Moreover, additional data populating a field for additional information can also be included in the call setup message signal. The additional data can represent for example, the purpose of the call, such a personal call or a business call or any other additional information.

### FIELD OF THE INVENTION

Disclosed are methods and devices for providing a called party's name to a setup message, and more particularly, transmitting the called party's name in a field of the setup message so that it can appear on a billing record.

### BACKGROUND

Communication device users receive billing records or telephone bills listing telephone numbers of called parties. A user may use the same telephone to make personal calls, business calls and calls related to specific matters such as volunteer work. Itemization of calls, for expense reporting and tax deductions for calling for business and charity may be important to some users. Without additional information such as the name of the called parties listed on the billing record, it can be difficult for users to determine the called party name as well as the purpose of the call.

### BRIEF DESCRIPTION OF THE DRAWINGS

FIG. 1 depicts an embodiment of a communication device;

FIG. 2 depicts operations involving an example sequence of user interfaces to initiate a communication;

FIG. 3 is a signal diagram between a mobile station, a base transceiver station, a base station controller, a mobile switching center and a billing system;

FIG. 4 is a diagram of traffic channels and control channels;

FIG. 5 is a flowchart of an embodiment of the described methods, including accessing the contact list of a communication device; and

FIG. 6 depicts an embodiment of a billing record.

### DETAILED DESCRIPTION

In a Call Setup (call setup is not part of the (RR) Radio Resource Connection Establishment) between a mobile station (MS), a Base Transceiver Station (BTS), a Base Station Controller (BSC) and a Mobile Switching Station (MSC) for Global System for Mobile Communication (GSM) or Universal Mobile Telecommunications Systems (UMTS) communication devices, a Setup Message from the MS to a network (NW) is provided. The Setup Message is provided within a control channel.

In radio communication, a control channel is a central channel that controls other constituent radios by handling data streams. In the GSM network the control channels can be divided into three categories: the Broadcast Control Channel (BCCH), the Common Control Channel (CCCH) and the Dedicated Control Channel (DCCH). The Dedicated Control Channel (DCCH) is a single timeslot on an RF carrier that is used to convey until eight Stand-alone Dedicated Control Channels (SDCCH). A single MS for call setup, authentication, location updating and SMS point to point use a SDCCH. An SDCCH has a maximum number of 251 bytes available. Typically, the bytes are occupied with data on bearer capability, call connection capability, supported codec, and the called party number which is used by a billing center beyond the MSC to generate a Caller Data Record (CDR). Accordingly, approximately 30 bytes of the available 251 bytes are utilized in the setup message.

The CDR includes the called party number that can be provided during a call setup message signal of a stand-alone dedicated control channel and is typically listed on the billing records or telephone bills of called parties by the MS. The called party number may be accessed for inclusion in the setup message signal by accessing a phonebook or contract list of the communication device of the calling party of the MS. It may be beneficial to also access from the phonebook and include in the call setup message the called party name so that it too can be listed on the billing records or telephone bills of called parties by the MS. Utilization of the above-discussed available bytes in the setup message that is transmitted via a control channel provides bandwidth for the identification field and other fields, when appropriate. In this way, users may be able to determine the called party name and/or the purpose of the call.

Disclosed are communication devices and methods of a communication devices that include accessing the contact list of the memory by the controller, initiating communication based upon the contact list input by the controller and generating by the controller, a setup message that includes communication address data populating a field for a communication address and includes identification data populating a field for identification information. The disclosed method can further include transmitting a call setup message signal of a control channel, such as a stand-alone dedicated control channel including a populated field for identification information. Moreover, additional data populating a field for additional information can also be included in the call setup message signal. The additional data can represent for example, the purpose of the call, such a personal call or a business call or any other additional information.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

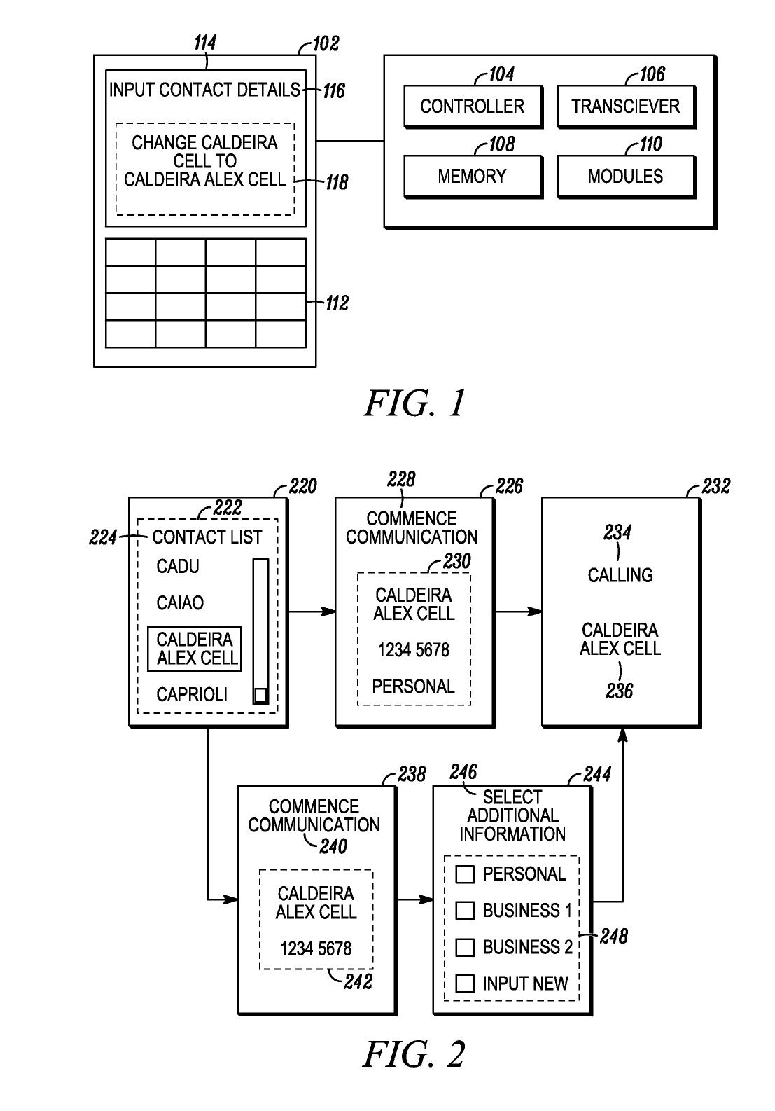

FIG. 1 depicts an embodiment of a communication device 102 including a controller or processor 104, a transceiver 106, a memory 108, modules 110 and an input device 112. While the input device 112 is depicted as a keypad, it is understood that the input device 112 can be of any configuration, such as touch display screen 114 and/or such as voice activation by a speech recognition module.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The memory 108 can store a contact list including contact details. A user can input contact details 116 such as the name and communication address of a contact. Once the contact details are stored in memory 108, for example in the form of a contact list, a user can change contact details 118. For example the contact details such as the name of a contact can be changed. In this example, the name is changed from Caldeira Cell to Caldeira Alex Cell. As will be discussed in more detail below, additional information can be provided to the contact details of a contact, for example, the reason for the contact. For example, the contact may be personal or may be a business contact. Those contact details, or any other contact details can be updated or changed at any suitable time by the user.

The modules 110 of the communication device can carry out certain processes of the methods as described herein including accessing the communication list when a communication is initiated. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

FIG. 2 depicts operations involving an example sequence of user interfaces to initiate a communication. A first user interface 220 that may displayed on the display screen 114 (see FIG. 1) may include a contact list 222 that is indicated within the dashed line box 224. A scroll bar depicted within the dashed line box 224 may enable a user to access the contact list. A desired contact of the contact list 222 may be highlighted. In this example, Caldeira Alex Cell is highlighted.

In the example user interface 226 communication can be commenced 228. Various communication details 230 of the selected contact may be displayed. In this example, the communication details include the called party name, Caldeira Alex Cell, the called number and a reason for the call, personal. The user interface 232 may then indicate the communication has commenced by the showing a term such as calling 234, and any suitable contact details such as the called party name 236.

In another example, the contact details may not necessarily include all information that can be included in fields provided by a setup message. As mentioned above, utilization of the above-discussed available bytes in the setup message that is transmitted via a control channel can provide bandwidth for the identification field and other fields, when appropriate. That is, there may be available fields in the setup message that are not populated. If a field is not populated, a message of the user interface may query the user.

A user interface 244 may allow the selection of additional information 246 such a the purpose of the call, which may be personal or business related, and/or provide for new input as depicted in the dashed box 248. In any event, the user interface 232 may then indicate the communication has commenced by the showing a term such as calling 234, and any suitable contact details such as the called party name 236. In this way, the device may be able to transmit the called party name and/or the purpose of the call in the setup message.

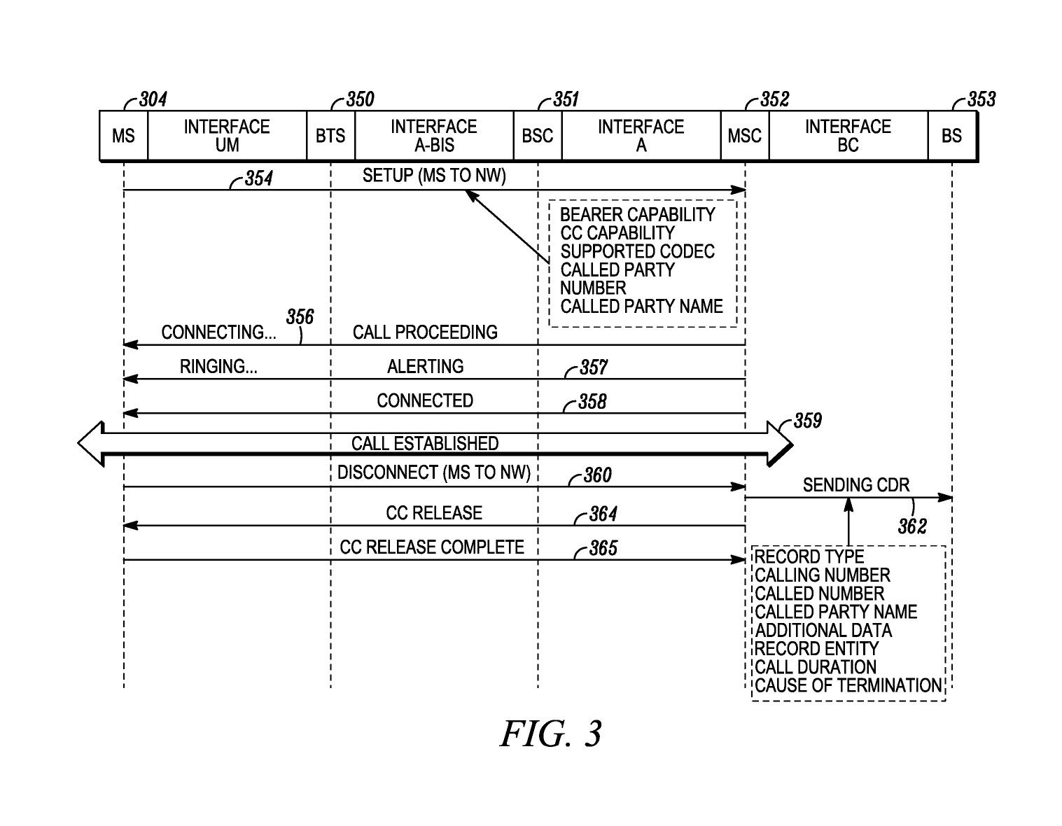

FIG. 3 is a signal diagram between a mobile station (MS) 304, a base transceiver station (BTS) 350, a base station controller (BSC) 351, a mobile switching center (MSC) 352 and a billing system (BS) 353. Um: interface is the air interface for the GSM mobile telephone standard; A-bis: interface between the BTS (Base Transceiver Station) and BSC (Base Station Controller); A: between the BSS (Base Station Subsystem) and an MSC (Mobile Switching Centre); and Bc: Reference point for the CDR file transfer from the Circuit Switched CGF to the BD. The above-discussed setup signal 354 (MS to the network (NW)) can include the bearer capability, the Call Control (CC) capability, the supported codec, called party number from the contact list and the called party name from the contact list.

The MSC server 352 is depicted as a remote server within a wireless communication network. The network of course may be any type of wireless network including an ad hoc or wireless personal area network, a Wifi or wireless local area network, and a cellular or wireless wide area network. Likewise, the server 352 may be of any suitable configuration. The server 352 may be implemented as a single server or as a plurality of servers in communication in any arrangement. The operations of the server 352 may be distributed among different servers or devices that may communicate in any manner.

The call is connected 356 and the ringing 357 is announced between MS 304 and the MSC 352. The call is connected 358, established 359 and then there is a disconnection 360 between MS and the NW, at which point the MSC can provide data to the billing system (BS). The data to the BS can include the record type, the calling number, the called number from the MS contact list, the called party name from the MS contact list, additional data from the contact list or from another memory file of the MS, or input to the MS, the record entity, the call duration and the cause of termination. The Control Channel release 354 and the response Control Channel release complete 365 can follow.

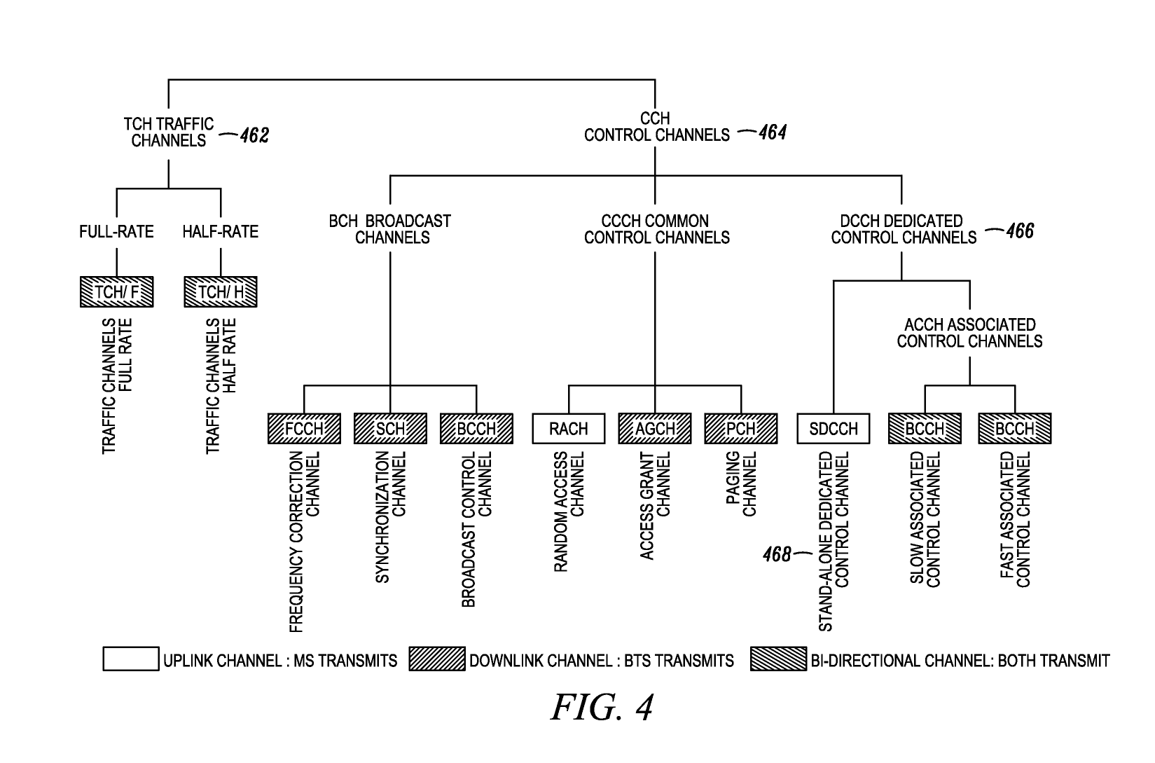

FIG. 4 is a diagram of traffic channels 462 and control channels 464. As mentioned above, in radio communication, control channels control other constituent radios by handling data streams. An SDCCH control channel can have 251 bytes. As mentioned, customarily, the typical usage is approximately 30 bytes. Therefore, there is enough space available to send the contact list name (see FIG. 2) on a call setup message. It is understood that any control channels 464, including the dedicated control channels 466 such as the stand-alone dedicated control channel 468 is within the scope of this discussion.

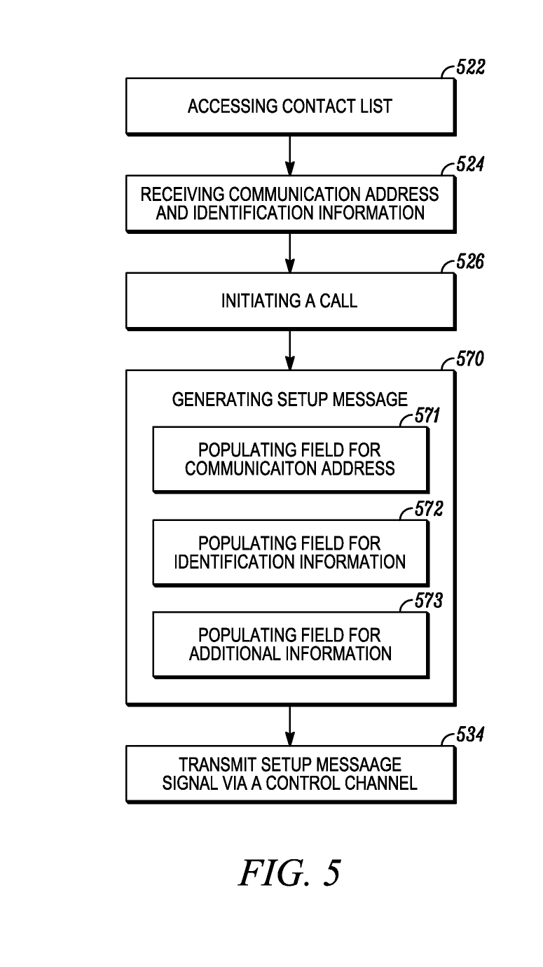

FIG. 5 is a flowchart of an embodiment of the described methods, including accessing the contact list 522 of a communication device 102 (see FIG. 1). The device 102 includes modules 110 that can provide instructions for accessing the contact list 522, receiving communication address and identification information 524, initiating a call 526 and generating a setup message 570 that includes populating fields for the communication address 571, identification information 572 as well as additional information 572 when appropriate.

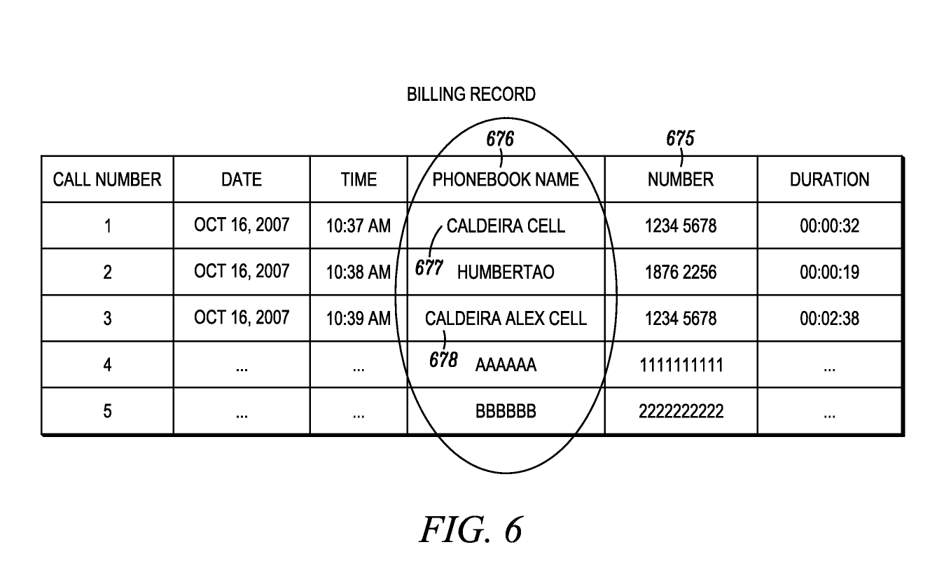

FIG. 6 depicts an embodiment of a billing record. The method of generating a billing record can include receiving setup message data that includes data from the setup message that includes data occupying a field for a communication address 675 and a data occupying a field for identification information 676 corresponding to the communication address and identification information transmitted by the mobile station and

generating billing information including data from the setup message that includes data occupying a field for a communication address and data occupying a field for identification information corresponding to the communication address and identification information transmitted by the mobile station. It should be noted that call number 1 and call number 3 have the same dialed number but the called party names 677 and 678 are different because the contact list was updated as depicted in on the display screen 114 of the device 102 in FIG. 1. Accordingly, because the contact data of the setup message is populated from the contact list, a change in the contact list would be reflected in the billing record of FIG. 6.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a communication device having a memory, a controller and a transceiver, the memory including a contact list having at least one communication address and identification information corresponding to the communication address, comprising:
accessing the contact list of the memory by the controller;
receiving contact list input of a communication address and the corresponding identification information from the memory by the controller;
initiating communication based upon the contact list input by the controller; and
generating by the controller, a setup message that includes communication address data populating a field for a communication address and includes identification data populating a field for identification information.

2. The method of claim 1, further comprising:
transmitting by the transceiver a call setup message signal of a control channel including the setup message.

3. The method of claim 2 wherein the control channel is a dedicated control channel.

4. The method of claim 2 wherein the control channel is a stand-alone dedicated control channel.

5. The method of claim 1, wherein the communication address represents a telephone number.

6. The method of claim 1, wherein the identification information represents a name of a called party.

7. The method of claim 1, further comprising:
generating by the controller, a setup message that further includes additional data populating a field for additional information.

8. The method of claim 7, additional data is stored in the contact list.

9. The method of claim 7, wherein upon initiating communication, additional data is provided by received input.

10. The method of claim 1, further comprising:
changing the identification information corresponding to a communication address from a first party name to a second party name;
storing the second party name in the contact list. prior to initiating communication.

11. A method of a communication device having a memory, a controller and a transmitter, the memory including a contact list having at least one communication address and identification information corresponding to the communication address, the method for generating a setup message signal of a stand-alone dedicated control channel, comprising:
populating by the controller a communication address field of the call setup message with a communication address; and
populating by the controller an identification information field of the call setup message with identification information corresponding to the communication address retrieved from the contact list of the memory.

12. The method of claim 11, further comprising:
transmitting by the transceiver a call setup message signal of a control channel including the setup message.

13. The method of claim 12 wherein the control channel is a dedicated control channel.

14. The method of claim 12 wherein the control channel is a stand-alone dedicated control channel.

15. The method of claim 11, wherein the communication address represents a telephone number stored in the contact list.

16. The method of claim 11, wherein the identification information represents a name of a called party stored in the contact list.

17. The method of claim 11, further comprising:
populating by the controller a field for additional information with additional data.

18. A method of a billing center configured to receive from a mobile service switching center data of a call setup message signal of a stand-alone dedicated control channel transmitted from a mobile station, comprising:
receiving setup message data that includes data from the setup message that includes data occupying a field for a communication address and a data occupying a field for identification information corresponding to the communication address and identification information transmitted by the mobile station; and
generating billing information including data from the setup message that includes data occupying a field for a communication address and data occupying a field for identification information corresponding to the communication address and identification information transmitted by the mobile station.

19. The method of claim 18, wherein the communication address represents a telephone number.

20. The method of claim 18, wherein the identification information represents a name of a called party.
